(19) United States
(12) Patent Application Publication
(10) Pub. No.: US 2006/0114802 A1
(43) Pub. Date: Jun. 1, 2006

(54) Archive media

(76) Inventors: Charles Marshall, Burbank, CA (US); John A. Trepl II, Dana Point, CA (US); Roger A. Kuntz, Laguna Niguel, CA (US); Axel M. Kuntz, Lake Forest, CA (US)

Correspondence Address: Zilka-Kotab, PC, P.O. BOX 721120, SAN JOSE, CA, 95172-1120, US

(21) Appl. No.: 11/001,198

(22) Filed: Nov. 30, 2004

(51) Int. Cl. G11B 7/24

(52) U.S. Cl. 369/275.1

(57) ABSTRACT

An optical medium having a substrate having a data track thereon being readable with an optical reader. The substrate is constructed of a corrosion-resistant material that does not substantially deteriorate over a period of one hundred years. No material covers the data track. An optical medium according to another embodiment includes a substrate having a data area and a periphery. A supplemental layer is coupled to the substrate in at least the data area, the supplemental layer having a data track thereon being readable with an optical reader. The substrate and supplemental layer are constructed of a corrosion-resistant material that does not substantially deteriorate over a period of one hundred years.

### FIELD OF THE INVENTION

The present invention relates to data storage media and more particularly, this invention relates to a long-term stable data storage medium.

### BACKGROUND OF THE INVENTION

The preservation of data and knowledge has been, and continues to be, one of the top priorities of modern civilization. Information is being produced in greater quantities and with greater frequency than at any time in history. Electronic media, especially the Internet, make it possible for almost anyone to become a “publisher.” The ease with which electronic information can be created and “published” makes much of what is available today, gone tomorrow. Thus there is an urgent need to preserve this information before it is forever lost.

Optical media presently include compact discs (CDs), digital video discs (DVDs), laser discs, and specialty items. Optical media has found great success as a medium for storing music, video and data due to its durability, long life, and low cost.

A CD typically comprises an underlayer of clear polycarbonate plastic. During manufacturing, the polycarbonate is injection molded against a master having protrusions (or pits) in a defined pattern that creates an impression of microscopic bumps arranged as a single, continuous, spiral track of data on the polycarbonate. Then, a thin, reflective aluminum layer is sputtered onto the disc, covering the bumps. Next a thin acrylic layer is sprayed over the aluminum to protect it. A label is then printed onto the acrylic. FIG. 1 illustrates a cross section of a typical data or audio CD 100, particularly depicting the polycarbonate layer 102, aluminum layer 104, acrylic layer 106, label 108, and pits 110 and lands 112 that represent the data stored on the CD 100. Note that the “pits” 110 are as viewed from the aluminum side, but on the side the laser reads from, they are bumps. The elongated bumps that make up the data track are each 0.5 microns wide, a minimum of 0.83 microns long and 125 nanometers high. The dimensions of a standard CD is about 1.2 millimeters thick and about 4.5 inches in diameter. A CD can hold about 740 MB of data.

During playback, the reader's laser beam passes through the polycarbonate layer, reflects off the aluminum layer and hits an opto-electronic device that detects changes in light. The bumps reflect light differently than the lands, and an opto-electronic sensor detects that change in reflectivity. The electronics in the reader interpret the changes in reflectivity in order to read the bits that make up the data.

The data stored on the CD is retrieved by a CD player that focuses a laser on the track of bumps. The laser beam passes through the polycarbonate layer, reflects off the aluminum layer and hits an opto-electronic device that detects changes in light. The bumps reflect light differently than the lands, and the opto-electronic sensor detects that change in reflectivity. The electronics in the drive interpret the changes in reflectivity in order to read the bits that make up the bytes.

A DVD is very similar to a CD, and is created and read in generally the same way (save for multilayer DVDs, described below). However, a standard DVD holds about seven times more data than a CD. Single-sided, single-layer DVDs can store about seven times more data than CDs. A large part of this increase comes from the pits and tracks being smaller on DVDs. To increase the storage capacity even more, a DVD can have multiple layers, several layers being readable on each side.

A DVD player functions similarly to the CD player described above. However, in a DVD player, the laser can focus either on the semi-transparent reflective material behind the closest layer, or, in the case of a double-layer disc, through this layer and onto the reflective material behind the inner layer. The laser beam passes through the polycarbonate layer, bounces off the reflective layer behind it and hits an opto-electronic device, which detects changes in light.

One problem with each of these technologies is that currently available media is unsuitable for long-term data storage, long term meaning one hundred years or more. The polycarbonate on the disc is porous, and allows water to wick into the structure. The water over time will corrode the metallic backlayer, eventually rendering the media unreadable. Additionally, the polymer coatings deteriorate over time. In the time of several hundred years, the polymer coatings could become so brittle that any attempts to read the media would result in destroying the disc. The discs may crack, even without any external forces being brought to bear thereon. Similarly, the dye layer in writeable media would also deteriorate over the course of several hundred years.

What is therefore needed is a way to collect, archive and preserve the burgeoning amounts of digital content, especially materials that are created only in digital formats, for current and future generations. To accomplish this, what is needed is a new data storage medium that is long-term stable. What is also needed is a data storage medium that is readable after 1000 years.

### SUMMARY OF THE INVENTION

To overcome the aforementioned drawbacks and provide the desirable advantages, an optical medium includes a substrate having a data track thereon being readable with an optical reader. The substrate is constructed of a corrosion-resistant material that does not substantially deteriorate over a period of one hundred years. In this embodiment, no material covers the data track.

An optical medium according to another embodiment includes a substrate having a data area and a periphery. A supplemental layer is coupled to the substrate in at least the data area, the supplemental layer having a data track thereon being readable with an optical reader. The substrate and supplemental layer are constructed of a corrosion-resistant material that does not substantially deteriorate over a period of one hundred years.

In one embodiment, the substrate includes a central hub, an outer periphery, and a data area extending between the hub and periphery, the data track being positioned in the data area. The data area can be recessed from a bottom plane of the medium, preferably such that the data track has a focal depth about the same as a focal depth of a compact disc (CD), digital video disc (DVD), etc. so that the data track is readable by a consumer-grade CD and/or DVD player

In a further embodiment, a second data area is positioned on an opposite side of the substrate relative to the first data track. As before, the second data area can be recessed from a top plane of the medium.

As an option, a peripheral flange may extend downwardly from the periphery.

Preferred materials from which the construct the substrate and/or supplemental layer include gold, ceramic, stainless steel, fused silica quartz, carbonite, a graphite composite, and combinations thereof.

Several options exist for creating the data track. One method includes forming the data track by stamping. The data track can also be formed by electron or ion exposure. The data track can also be formed by electrons or ions passing through apertures of a mask.

Accordingly, the optical media described herein provides an archive medium that is particularly adapted for long term storage off data including audio data, video data, and software.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a partial cross sectional view, not to scale, of a CD.

FIG. 2 is a side view, not to scale, of a data storage medium according to one embodiment.

FIG. 3 is a cross sectional view, not to scale, of the medium of FIG. 2 taken along line 3-3 of FIG. 2.

FIG. 4 is a detailed view, not to scale, taken from circle 4 of FIG. 3.

FIG. 5 is a cross sectional view, not to scale, of a data storage medium according to one embodiment.

FIGS. 6A-E are detailed views, not to scale, taken from circle 6A/B/C/D/E of FIG. 5.

FIG. 7 is a cross sectional view, not to scale, of a data storage medium according to one embodiment.

FIG. 8 is a representative system diagram of a system for writing data to an optical medium according to one embodiment.

FIG. 9 is a flow diagram of a method for writing data to a standard CD or a single or double sided, single layer (per side) DVD according to an illustrative embodiment.

FIG. 10 is a side view of a surface feature created by an electron beam.

FIGS. 11A-B is a partial cross sectional view, not to scale, of another embodiment of an optical medium.

FIG. 12 is a representative system diagram of a system for writing data to an optical medium according to one embodiment.

FIG. 13 is a perspective view of a mask used when writing data to a medium.

FIG. 14 is a detailed view taken from Circle 14 of FIG. 13.

FIG. 15A is a detailed view taken along line 15-15 of FIG. 14.

FIG. 15B is a variation of FIG. 15A.

FIG. 16 is a detailed view taken from Circle 16 of FIG. 14.

FIG. 17 is a side view of a surface feature created by an electron or ion beam in conjunction with masking.

FIG. 18 is a flow diagram of a method for creating a mask according to an illustrative embodiment.

FIG. 19 is a flow diagram of a method for writing data to a medium according to an illustrative embodiment.

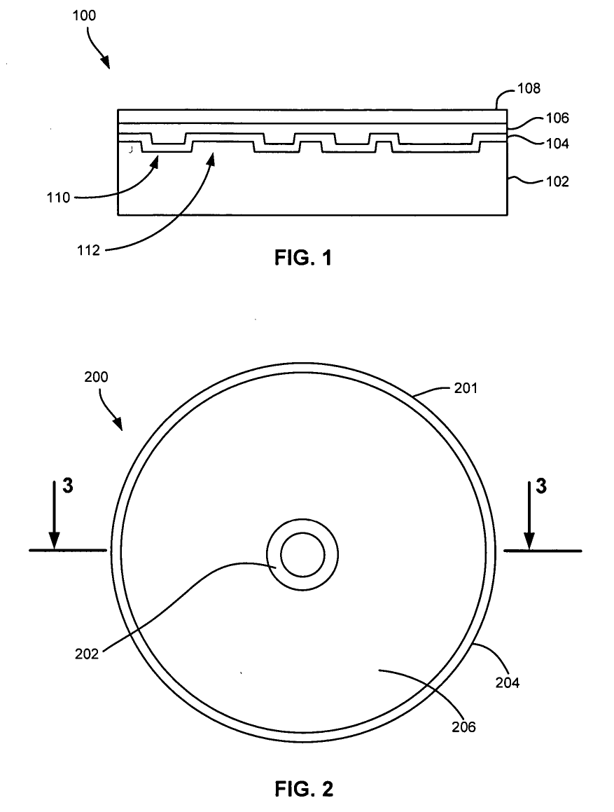

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

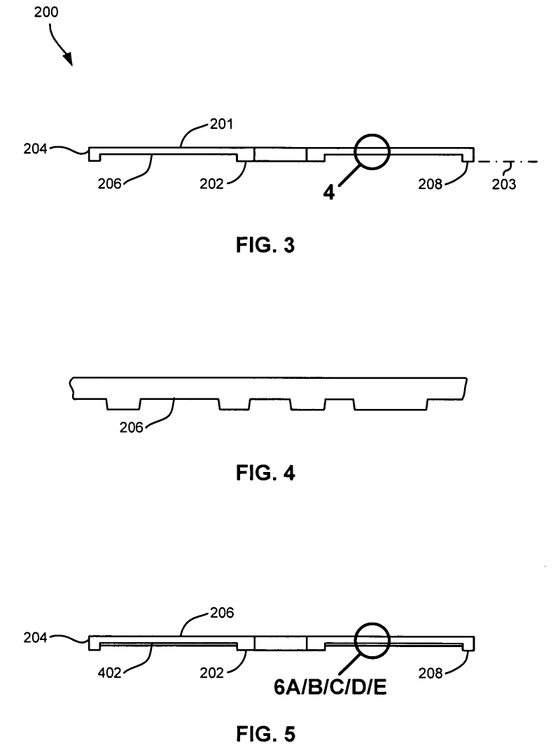

FIG. 2 illustrates an archive-quality long-term-stable data storage medium 200 according to one embodiment. FIG. 3 shows a cross-sectional view, not to scale, of the medium 200. As shown the medium 200 is generally annular and of a unitary design, preferably having dimensions similar to a standard CD, DVD, mini-CD, laser disc, etc. The medium includes a substrate 201 having a central hub 202, an outer periphery 204, and a data area 206 extending between the hub 202 and periphery 204.

The data area in this embodiment includes a data track that is preferably readable using a standard optical media reader, e.g., CD or DVD drive. Note FIG. 4. The data area in this embodiment is not covered with any material, but rather is exposed. In other words, the data track is formed directly on the substrate. This prevents moisture from accumulating between layers and, over time, corroding or deteriorating the data track. Rather, the data area is non-transmissive, i.e., the pits and lands are read directly from the exposed surface as a data track of a CD or DVD is read. Accordingly, the outer surface of the substrate is preferably reflective.

As shown particularly in FIG. 3, the data area is recessed from the bottom plane 203 of the medium 200. To ensure interoperability with standard optical media readers (if desired), the plane of the data area has about the same focal depth of a CD (0.8 mm) or DVD backlayer. The hub 202, extending downwardly, maintains the proper distance between the laser and the optical surface of the data area. Thus, the exposed surface of the data area functions as if it were a backlayer of a standard CD or DVD.

A peripheral flange 208 may extend downwardly from the periphery 204 of the medium 200. The flange may or may not have the same axial thickness as the hub 202. The flange serves a protective role, keeping the data area of the disk from contacting a surface upon which it is resting, thereby preventing scratching and soiling of the data area. The flange can also be used to stabilize the disk in a reader, e.g., rollers could engage the flange.

At least the data area, and preferably the entire medium 200, is fabricated of a material that is durable, corrosion-resistant, and does not deteriorate over time, e.g., at least 100 years. Illustrative materials include gold, ceramic, stainless steel, fused silica quartz, carbonite, graphite composites, etc. Such materials are believed to be able to maintain a readable data track for a minimum of about 1000 years. Gold is a preferred material, as it is reflective, and will not move or deteriorate. Also, after several hundred years in storage, the user may need to clean the data area before use. Because gold is very noncorrosive, a mild acid, solvents, etc. can be used to clean the exposed data area. In applications where fire resistance is desired, a material having a high melting point can be selected.

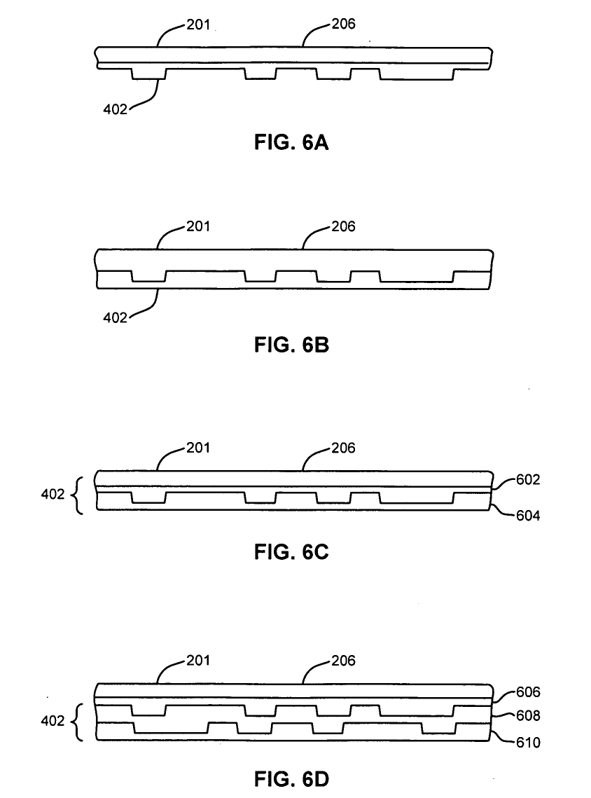

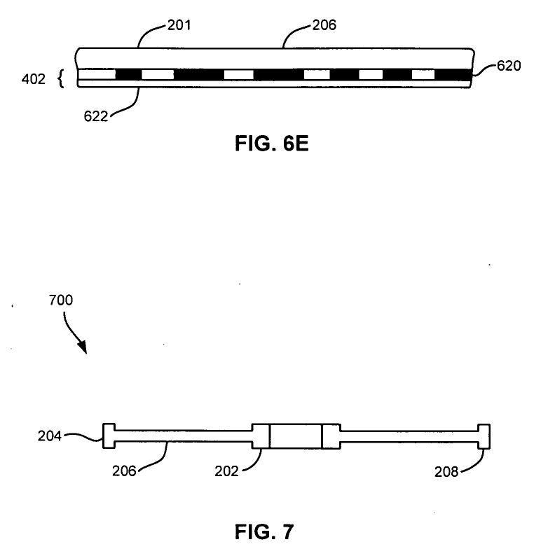

In another embodiment, shown in FIG. 5, the data area includes a supplemental layer 502. This supplemental layer 502 of material will likewise be very corrosion resistant and non-deteriorating. As shown in FIG. 6A, the data track can be written on the supplemental layer 502. This embodiment would be useful where one desires to write the data track to a gold surface but also wants to reduce the overall cost per medium 200. In one embodiment, a supplemental layer 502 of gold can be coupled to a carbon-based substrate.

As shown in FIG. 6B, the supplemental layer 502 can also be a protective coating that is optically transmissive but does not allow the elements to reach the data track on the underlying data surface. (As mentioned above, traditional polymeric overcoats deteriorate and tend to wick water to the data surface.) One suitable protective coating is an optical diamond material, e.g., diamond-like carbon (DLC).

As shown in FIG. 6C, the supplemental layer 502 can also include multiple sublayers 602, 604. For instance, a gold sublayer 602 can store the data while an outer protective overcoat sublayer 604 protects the gold data sublayer 602. FIG. 6D illustrates another embodiment in which the supplemental layer 502 includes multiple data sublayers 606, 608. This structure functions similar to the way current multi-layer DVD's store data. To form this disc, each sublayer 606, 608 is created with a single, continuous and extremely long spiral track of data as described herein. Once the clear portions of each sublayer 606, 608 are formed, a thin reflective layer is sputtered onto each sublayer 606, 608, covering the bumps. A noncorrrosive metal, e.g., gold is used behind the inner sublayer 606, but a semi-reflective gold layer is used for the outer sublayer(s) 608, allowing a laser to focus through the outer and onto the inner sublayers. After all of the sublayers 606, 608 are made, they are coupled together. Because lacquer adhesives may deteriorate over time, the sublayers 606, 608 can be compression-fitted between the hub 202 and the peripheral flange, where they are held in place by friction.

Optionally, an optically transmissive protective outer sublayer 610, e.g., of diamond-like carbon, can be added.

As shown in FIG. 6E, a variation on the above has a dye sublayer 620 that is stable enough to withstand the rigors of time. The dye sublayer 620 is covered with a protective sublayer 622 and written to with energy exposure e.g., using a laser as in a standard CD-R.

FIG. 7 illustrates a medium 700 having two data sides. Each data side will have essentially the same configuration as described above.

The data track can be a single, continuous and extremely long spiral track of data, as is typical of current CDs and DVDs for compatibility with current optical readers. The data track can also be formed in linear rows, or any other desired pattern. The surface features, e.g., pits and lands, of the data track are readable with an optical reading device. The data track can be formed on the data area of the medium shown in FIGS. 2 and 6B, or the data sublayers of FIGS. 6A, 6C, 6D using any of several methods. One method uses a master to stamp the data area to form the surface features comprising the data track. The stamping process is similar to the glass-mastering process currently used to imprint a data pattern in polycarbonate-based discs. In embodiments where the material used to create the medium is soft, e.g., gold, the material will readily receive the data imprint from the master. However, in other embodiments where the material used to create the medium is very hard, the medium or sublayers may be formed around the master. Alternatively, the material may need to be softened, such as by heating prior to pressing the master thereagainst.

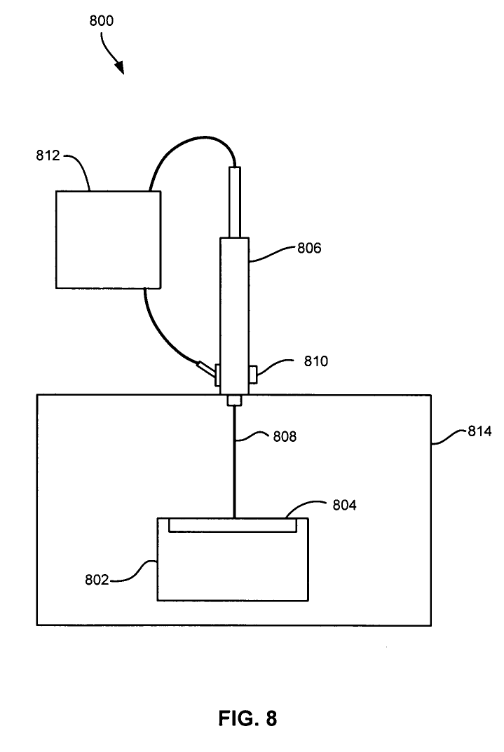

The data track can also be formed using electron or ion beam technology. FIG. 8 illustrates a system 800 for writing data to an optical medium according to one embodiment. The system 800 includes a medium receiving portion 802 for holding a target optical medium 804, an electron or ion source 806 such as an electron or ion gun for emitting a beam 808 of electrons or ions at the optical medium on the medium receiving portion 802, and a steering mechanism 810, which may be integral with the gun 806, for directing the electron or ion beam 808 onto the optical medium 804 in a controlled manner such as in a spiral, concentric circles, straight lines, etc. A controller 812 controls operation of the system components. The beam of electrons 808 is made to strike the optical medium 804 intermittently so that surface features are created on the optical medium 804. Particularly, the electron or ion beam 808 displaces or oblates the material it strikes, creating pits. The resultant pits and lands along the data track represent data. At least the medium receiving portion 802 should be positioned in a vacuum chamber 814 maintained at a vacuum of 1×10⁻³ Torr or below. Note that the emitting portion of the gun 806 should also be positioned in the vacuum chamber 814.

Accordingly, standard electron or ion beam lithography machine sinter technology can be combined with raster image control technology to write an image pattern to target media, thereby combining the fine feature size detail of electron or ion beam lithography with the imaging speed of rastering.

The system described herein can write data such as audio data, video data, software, etc. to an optical medium very quickly, e.g., in less than one minute, and even in less than one second. The system is able to write data to any type of optical media of any material, and would extend to future types of optical media that are presently under development or have yet to be discovered.

Electron guns have been widely used in the semiconductor industry to define electronic components with features down to about 5 nanometers. Such guns are suitable for use in the present invention. In general, an electron gun includes a small heater that heats a cathode. When heated, the cathode emits a cloud of electrons. Two anodes turn the cloud into an electron beam. An accelerating anode attracts the electrons and accelerates them toward the target (here, an optical medium) at a very high speed. A focusing anode, e.g., deflection plates and Einzel lens, focuses the stream of electrons into a very fine beam. By adjusting the power to the accelerating anode, the speed of the electrons, and thus their energy, can be set to create the desired depth of the pits being created on the medium. By adjusting the power to the heater, the number of electrons emitted can be controlled, which in turn affects the depth and width of the pits.

Many cathode types and sizes are available: tantalum disc cathodes, tungsten hairpins, single-crystal lanthanum hexaboride (LaB₆) cathodes, barium oxide (BaO) cathodes, or thoria-coated (ThO₂) iridium cathodes. UHV technology is preferably used throughout. The guns can be run in vacuums from 10⁻¹¹ torr up to 10⁻⁵ torr for the various refractory metal cathodes. A minimum vacuum recommended for LaB₆ or BaO cathodes is roughly 1×10⁻⁷ torr. Thoria cathodes can be run up to 10⁻⁴ torr and above

Suitable electron guns include the EGG-3101, EGPS-3101, EMG-12, and EGPS-12 available from Kimball Physics, 311 Kimball Hill Road, Wilton, N.H. 03086-9742 USA. One skilled in the art will recognize that there are several manufacturers of electron guns that are also suitable for use with the system, including those having larger and smaller spot sizes.

Where ion beam technology is used, the system of the present invention can incorporate therein a positive ion source or a negative ion source. Illustrative ion species which perform the bombardment are Ar+, O₂+, Ga+, Cs+, Li+, Na+, K+, Rb+, etc.

A preferred embodiment implements a Focused Ion Beam (FIB) system. A FIB system takes charged particles from a source, focuses them into a beam through electromagnetic/electrostatic lenses, and then scans across small areas of the target using deflection plates or scan coils. The FIB system produces high resolution imaging by collecting the secondary electron emission produced by the beam's interaction with the target surface. Contrast is formed by raised areas of the sample (hills) producing more secondary electrons than depressed areas (valleys).

In a preferred embodiment, the FIB system uses gallium ions from a field emission liquid metal ion (FE-LMI) source. In operation, a gallium (Ga⁺) primary ion beam hits the sample surface and sputters a small amount of material, the displaced material leaving the surface as either secondary ions (i⁺ or i⁻) or neutral atoms (n⁰). The primary ion beam also produces secondary electrons (e-). As the primary beam rasters on the sample surface, the signal from the sputtered ions or secondary electrons is collected to form an image.

At low primary beam currents, very little material is sputtered; modern FIB systems can achieve 5 nm imaging resolution. At higher primary currents, a great deal of material can be removed by sputtering, allowing precision milling of the specimen down to a sub-micron scale.

Many variables and material properties affect the sputtering rate of a sample. These include beam current, sample density, sample atomic mass, and incoming ion mass. A preferred ion species is Ga+.

Additionally, gas-assisted etching can be used. When a gas is introduced near the surface of the sample during milling, the sputtering yield can increase depending on the chemistry between the gas and the sample. For instance, by injecting a reactive gas into the mill process, the aspect ratio of the ion beam's cutting depth can be dramatically altered such that it is possible to reach the lower metallization line without disturbing the upper layer metallization. This results in less redeposition and more efficient milling. Two typical gasses are iodine and xenon difluoride.

If the sample is non-conductive, a low energy electron flood gun can be used to provide charge neutralization. In this manner, by imaging with positive secondary ions using the positive primary ion beam, even highly insulating samples may be imaged and milled without a conducting surface coating, as would be required in a SEM. This feature is particularly useful for writing surface features directly to the polymeric layer of an optical medium.

Suitable ion guns include the ILG-2, IGPS-2, E/IMG-16, E/IGPS-16, available from Kimball Physics, 311 Kimball Hill Road, Wilton, N.H. 03086-9742 USA. Another suitable ion gun is the IOG 25 Gallium Liquid Metal Ion Gun, available from Ionoptika Ltd, Epsilon House, Chilworth Science Park, Southampton, Hampshire SO16 7NS, UK. One skilled in the art will recognize that there are several manufacturers of ion guns that are also suitable for use with the system, including those having larger and smaller spot sizes.

In both the electron beam and ion beam systems, the steering mechanism can use rastering technology to aim the electron beam at the optical medium along the data path. One preferred steering mechanism includes steering coils under control of the controller. Steering coils are copper windings that create magnetic fields that affect the direction of the electron beam. One set of coils creates a magnetic field that moves the electron beam in the X direction, while another set moves the beam in the Y direction. By controlling the voltages in the coils, the electron beam can be positioned at any point on the medium. Because rastering can be performed very quickly, a full data track can be transferred to the optical medium in a fraction of a second.

The raster pattern can be generated by a computer using a standard X-Y grid corresponding to points on the medium. The grid has a density sufficient to allow writing to all necessary points on the medium. The steering mechanism, in turn, directs the electron beam to the points on the medium corresponding to data points on the grid, where a pulse is emitted. A simple raster controller in this type of system can be similar to the controller used in cathode ray tubes (CRTs).

Alternatively, the raster pattern can be set to follow a data track, such as a spiral. The steering coils are energized in such a way that the electron beam moves along the data track, the electron beam pulsing at selected points along the data track. In this type of system, for example, the field emitted by the steering coils in the X and Y directions can follow generally sinusoidal curves where the amplitudes of the curves gradually increase as the beam moves from the inner diameter of the media to its periphery along a spiral data track.

As mentioned above, the surface features are created by electron or ion beam pulses. In most electron or ion guns, including those available from Kimball Physics, the beam may be turned off and on while the gun is running. The way this is accomplished depends on the particular gun design. Often several beam pulsing methods are available for a particular gun.

Pulsing includes stopping and starting the flow of electrons or ions in a fast cycle. This pulsing is usually accomplished by rapidly switching the grid voltage to its cut off potential to stop the beam. The grid provides the first control over the beam and usually can be used to shut off the beam. In an electron gun, if the grid voltage is sufficiently negative with respect to the cathode, it will suppress the emission of the electrons, first from the edge of the cathode and at higher (more negative) voltages from the entire cathode surface. The minimum voltage required to completely shut off the flow of electrons to the target is called the grid cut off. The grid voltage can be controlled by the controller manipulating the power supply; thus, in most guns, the beam can be turned off while the gun is running by setting the grid to the cut off voltage.

The grid voltage can be controlled by several different methods, one being capacitive. Many guns can be equipped with a capacitor-containing device (either a separate pulse junction box or cylinder, or a cable with a box) that receives a signal from an external pulse generator (available from the gun manufacturer). The grid power supply and pulse generator outputs are superimposed to produce the voltage at the grid aperture. The general pattern of the beam pulsing is a square wave with a variable width (time off and time on) and a variable repetition rate. Capacitive pulsing can provide the fastest rise/fall time and shortest pulse length of the various methods. However, the capacitor does not permit long pulses or DC operation. If there is a separate grid lead on the gun, this capacitive pulsing option can be added to most existing gun systems without modification.

A typical pulse length is ˜20-100 nanoseconds, defined as the time the beam is on, measured as the width at 50% of full beam and may include some ringing. The rise/fall time is typically ˜10 nanoseconds measured between 10% and 90% of full beam. Shortening the rise/fall will typically increase ringing. Pulsing performance may also depend on the performance of the user-supplied pulse generator.

Not all guns are designed to be pulsed. For example, a few electron guns have a positive grid in order to extract more electrons, and so these guns do not usually have grid cut off, unless a dual grid supply is ordered. In some high-current electron guns, the optical design, the position of the cathode, does not allow for cut-off with the grid, and so a different option, called blanking, must be used to interrupt the beam instead of pulsing.

Beam blanking deflects the electron beam to one side of the electron gun tube to interrupt the flow of electrons to the target without actually turning off the beam. The voltage applied to the blanker plate in the gun is controlled by a potentiometer on the power supply. Blanking can be used to pulse the final beam current repeatedly on and off in response to a TTL signal input. The blanker voltage required for beam cutoff depends on the gun configuration and on the beam energy, and can be readily determined from the reference materials accompanying the electron gun from the manufacturer.

In both the electron and ion beam methods, the surface features can be made significantly smaller than has heretofore been possible. This is due to the fine detail (e.g., ˜5 nanometer) and sharp edges afforded by electron beam technology. For instance, the surface features can have a length along a data track thereof of less than about 500 nanometers, less than about 200 nanometers, less than about 100 nanometers, and less than about 50 nanometers. In this way, the data storable on a single medium can be greatly improved, limited only by the wavelength of the optical system used. For discs having surface features finer than a DVD, a reader capable of reading finer-than-DVD features is used. For even finer surface features, for example, ultraviolet, microwave and x-ray optical systems may be required.

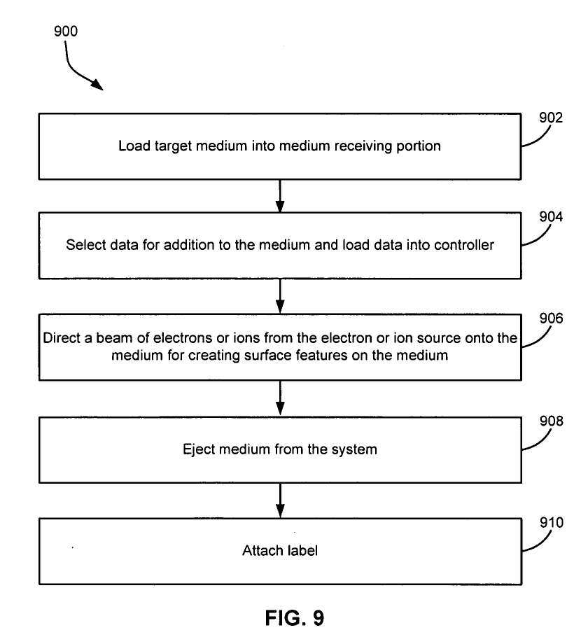

FIG. 9 depicts a method 900 for writing data to a medium using electron or ion beam technology. In operation 902, the target disc is loaded into the medium receiving portion either manually or by an automated system. The medium receiving portion preferably holds the target disc in a fixed position so that movement is eliminated. The data area faces the electron gun. In operation 904, data is selected for addition to the disc and loaded into the controller. In operation 906, under control of the controller, a beam of electrons or ions from the electron or ion gun is directed onto the disc for creating surface features on the disc. The electron beam is caused to pulse intermittently in a controlled manner to create the surface features along the data track, the surface features representing data in a data track. The resulting data track can be a spiral pattern starting from the inner diameter of the disc. The power of the electron or ion beam is set such that it will create optically discernable features on the reflective layer. For a CD, the data points are about 0.5 microns (500 nanometers) wide, and a minimum of 0.83 (830 nanometers) microns long. The track spacing is about 6 microns (6000 nanometers). In a DVD, the damaged sections of the reflective layer that make up the data track are each about 320 nanometers wide and a minimum of 400 nanometers long. The track spacing is about 740 nanometers.

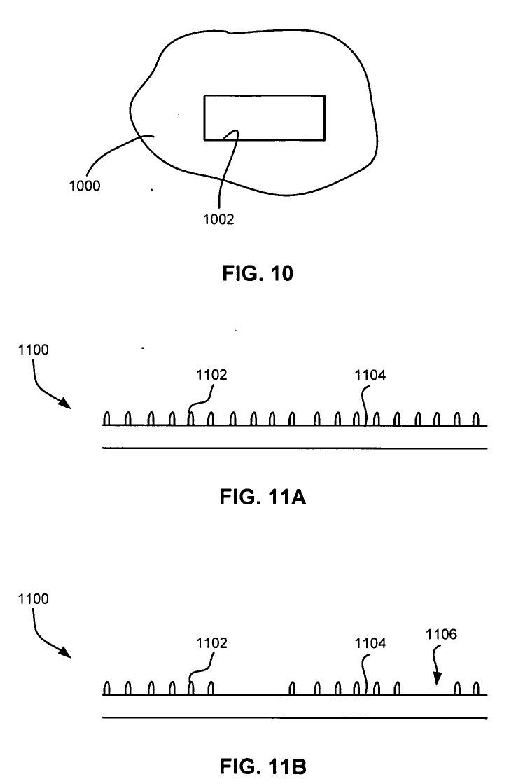

Also note that the surface features created can have almost perfectly straight edges. FIG. 10 illustrates a surface of a media 1000 formed as above having a surface feature 1002 formed by an electron or ion beam. Unlike standard media, the electron or ion beam-created surface features 1002 have very straight edges and sharp corners. The resultant media have been found to have much less jitter than optical media heretofore known.

In another variation, the electron or ion beam can be used to create “pits and lands” of varying reflectivity on a surface having nanostructures that affect the reflectivity of light. The shapes of the nanostructures determine the amount of reflectivity (if any) of the surface. Thus, a reflective layer is not needed. Those skilled in the art will appreciate that the shape and size of the nanofeatures can vary, and will be able to select a shape and size without undue experimentation. FIG. 11A shows an illustrative media layer 1100 having a data area covered with nanofeatures 1102. The layer 1100 can be created with the nanofeatures so that it begins life in a substantially nonreflective state. Or the nanofeatures 1102 can be created on a reflective surface by stamping, molding, etc. To write to the media, the electron or ion beam melts or oblates the nanofeatures 1102, creating or exposing reflective areas 1106 on the surface 1104. This is shown in FIG. 11B. Thus “pits and lands” are created, which can be read by measuring the change in reflectivity as the laser reads the media.

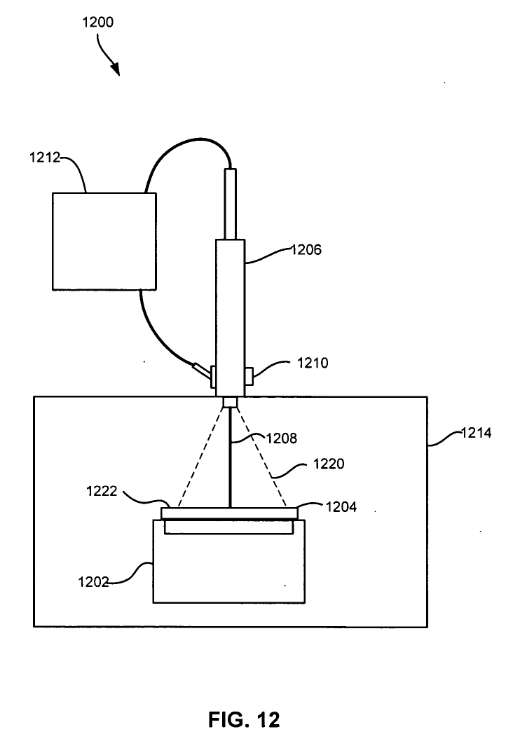

FIG. 12 illustrates a system 1200 for writing data to an optical medium according to another embodiment, this time using a masking technique. The system 1200 includes a medium receiving portion 1202 for holding a target optical medium 1204, and an electron or ion source 1206 such as an electron or ion gun for emitting a beam 1208 or flood 1220 of electrons or ions at the optical medium on the medium receiving portion 1202. A controller 1212 controls operation of the system components. An optional steering mechanism 1210, which may be integral with the gun 1206, can be provided to directing the electron or ion beam 1208 onto the optical medium 1204 in a controlled manner such as in a spiral, concentric circles, straight lines, etc. The beam 1208 of electrons or ions may be diffuse, or may be focused, depending on the desired operating parameters.

A electron or ion mill-resistant mask 1222 is placed over the medium 1204. The mask 1222 has apertures therethrough in a data track pattern representing the desired pit structure to be transferred to the optical medium 1204.

The beam 1208 or flood 1220 of electrons or ions is directed at the mask 1222. If a diffuse beam is being used, for instance, the steering mechanism 1210 can be used to sweep the beam 1208 across the medium 1204. The steering mechanism 1210 can also be used in conjunction with a beam blanker (not shown) to sequentially bombard different sections of the mask 1222 and medium 1204. Some electrons or ions pass through the apertures of the mask 1222 and bombard the optical medium 1204 in the data track pattern, thereby creating surface features on the optical medium 1204. Particularly, the electrons or ions displace or oblate the material they strike, creating pits. The resultant pits and lands along the data track represent data. At least the medium receiving portion 1202 should be positioned in a vacuum chamber 1214 maintained at a vacuum of 1×10⁻³ Torr or below. Note that the emitting portion of the gun 1206 should also be positioned in the vacuum chamber 1214.

The mask 1222, which will be described in more detail below, can be reused to create many copies of the media. And because commercially available media is formed of relatively soft materials (e.g., polycarbonate and aluminum), the electron or ion source 1206 can be operated at a lower power, thereby reducing the wear on the mask.

Accordingly, standard electron or ion beam lithography machine sinter technology can be combined with reusable masking technology to write an image pattern to target media, thereby combining the fine feature size detail of electron or ion beam lithography with the imaging speed of masking.

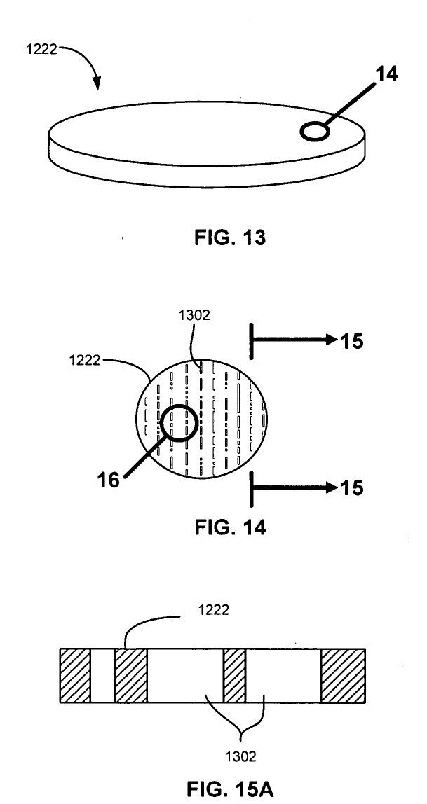

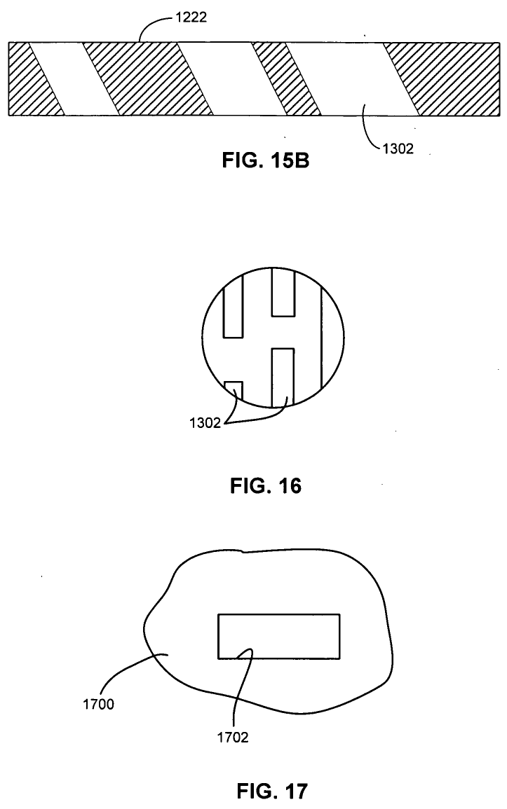

FIGS. 13-16 illustrate a mask 1222 for writing data to a medium. As shown, the mask 1222 has several apertures 1302 arranged in a spiral. The apertures 1302 have a standard width taken generally perpendicular to the data track. However, the length and spacing of the apertures 1302 along the data track will vary to correspond to the surface features to be created on the medium. As shown in FIG. 15A, the apertures 1302 can have sidewalls perpendicular to the plane of the mask 1222. Alternatively, as depicted in FIG. 15B, to account for the central location of the ion or electron source, some of the apertures 1302 can have angled walls corresponding generally to the electron or ion approach path.

Referring to FIG. 16, it can be seen that the apertures 1302 have straight edges and generally perpendicular corners. The resultant surface features created on the media will also have almost perfectly straight edges. FIG. 17 illustrates a surface of a media 1700 formed as above having a surface feature 1702 formed by an electron or ion beam in combination with masking. Unlike standard media, the electron or ion beam-created surface features 1702 have very straight edges and sharp corners. The resultant media has at least 2-3× better resolution, as beveled edges and round corners are not required for release, as is required by a stamper. Further, the degradation of the disc from contact with a stamper is completely avoided. The higher resolution and reduced degradation results in much less jitter than optical media heretofore known. The end result is that the data quality is far superior than has been heretofore known.

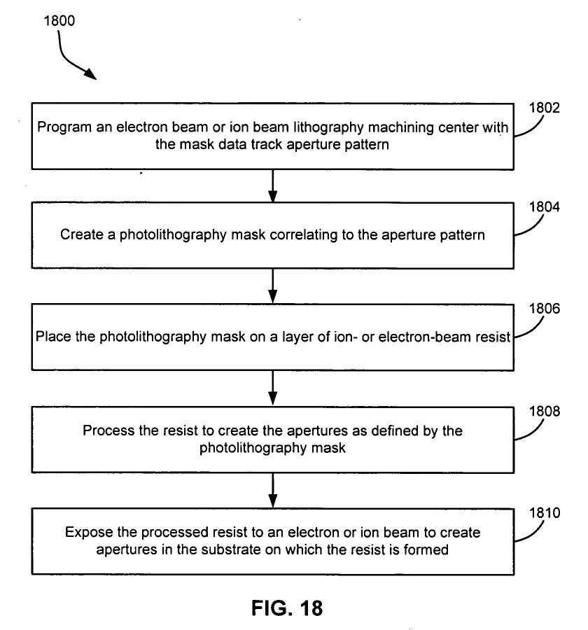

FIG. 18 depicts one process 1800 to create the mask 1222. In step 1802, an electron beam or ion beam lithography machining center is programmed with the mask data track aperture pattern. In step 1804, a photolithography mask is created, correlating to the aperture pattern. The photolithography mask is placed on a layer of ion- or electron-beam resist in step 1806 (which will ultimately be the mask used in the ion or electron system). In step 1808, the resist is processed to create the apertures as defined by the photolithography mask. In step 1810, the processed resist can be exposed to an electron or ion beam to create apertures in the substrate on which the resist is formed. Essentially, the features of the patterned resist are transferred to the underlying substrate. Preferably, the substrate is of a soft material, in that it will easily etch away under the ion or electron bombardment without substantial loss of the overlying resist. (As mentioned above, during creation of media, a low energy electron or ion exposure is used, resulting in little loss of the resist. However, it is desirable to maintain a thickness sufficient to protect the integrity of the resist structure.) Any redeposited material in the apertures of the resist can be removed by performing a clean-up exposure.

In a variation, the substrate upon which the resist rests can be of a durable material that is ion or electron mill resistant. The resist is formed to a height high enough to withstand substantial milling. Upon patterning of the resist, the structure is milled to create the apertures in the substrate. The resist will be milled away as well, but due to the increased height, will remain long enough to allow defining of the apertures in the substrate. Then the resist can be removed from the substrate, leaving a mill resistant mask having a long life.

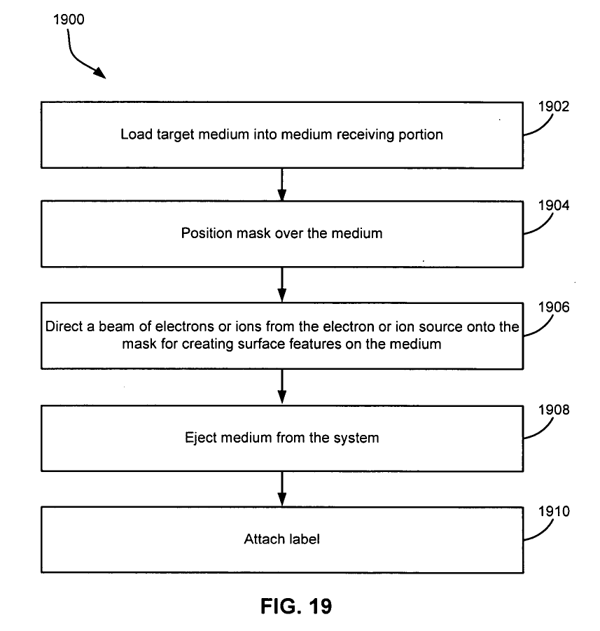

FIG. 19 depicts a method 1900 for writing data to a medium (e.g., CD, DVD) using electron or ion beam technology. In operation 1902, the target disc is loaded into the medium receiving portion either manually or by an automated system. The medium receiving portion preferably holds the target disc in a fixed position so that movement is eliminated. The data area faces the electron gun. In operation 1904, the mask is positioned over the medium. In operation 1906, under control of the controller, a beam of electrons or ions from the electron or ion gun is directed onto the mask for creating surface features on the medium. A diffuse electron or ion beam is directed towards the mask in a controlled manner to create the surface features on the medium when the electrons or ions pass through the apertures in the mask and onto the medium and material is milled therefrom. The power level of the electron or ion beam is preferably selected to create pits of a desired depth in the medium, while minimizing wear on the resist. The resultant surface features represent data in a data track. The resulting data track can be a spiral pattern starting from the inner diameter of the disc. The power and duration of the electron or ion beam are set such that they will create optically discernable features on the reflective layer. For a CD, the data points are about 0.5 microns (500 nanometers) wide, and a minimum of 0.83 (830 nanometers) microns long. The track spacing is about 6 microns (6000 nanometers). In a DVD, the damaged sections of the reflective layer that make up the data track are each about 320 nanometers wide and a minimum of 400 nanometers long. The track spacing is about 740 nanometers.

In operation 1908, the medium is ejected from the system. In operation 1910, a label is then printed onto the medium using a printing device known in the art, or affixed as an adhesive layer. In this way, the damaged area of the medium is covered and is nonapparent to the end user. The side of the label adjacent the medium is preferably nonreflective so as not to reflect the reader's laser during playback. Also note that a protective layer can optionally be added prior to affixing the label.

In a variation on the above, the beam of electrons or ions is swept across the mask in a controlled manner, such as in a serpentine path, back and forth along parallel paths, etc. In a further variation, instead of sweeping the beam across the mask, areas of the mask are sequentially exposed by a flood of electrons or ions. In either of these embodiments, a beam blanker, pulse generator, on/off control, etc. can be used to control the duration of the exposure.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An optical medium, comprising:
a substrate having a data track thereon being readable with an optical reader,
wherein the substrate is constructed of a corrosion-resistant material that does not substantially deteriorate over a period of one hundred years;
wherein no material covers the data track.

2. The optical medium as recited in claim 1, wherein the substrate includes a central hub, an outer periphery, and a data area extending between the hub and periphery, the data track being positioned in the data area.

3. The optical medium as recited in claim 2, wherein the data area is recessed from a bottom plane of the medium.

4. The optical medium as recited in claim 3, wherein the data track has a focal depth about the same as a focal depth of a compact disc (CD).

5. The optical medium as recited in claim 3 further comprising a second data area positioned on an opposite side of the substrate.

6. The optical medium as recited in claim 5, wherein the second data area is recessed from a top plane of the medium.

7. The optical medium as recited in claim 2, further comprising a peripheral flange extending downwardly from the periphery.

8. The optical medium as recited in claim 1, wherein the data track has a generally spiral shape.

9. The optical medium as recited in claim 1, wherein the optical medium is readable by a consumer-grade compact disc (CD) player.

10. The optical medium as recited in claim 1, wherein the optical medium is readable by a consumer-grade digital video disc (DVD) player.

11. The optical medium as recited in claim 1, wherein the optical medium is readable by a reader capable of reading surface features finer than a consumer-grade digital video disc (DVD) player.

12. The optical medium as recited in claim 1, wherein the substrate is constructed of gold.

13. The optical medium as recited in claim 1, wherein the substrate is constructed of ceramic.

14. The optical medium as recited in claim 1, wherein the substrate is constructed of stainless steel.

15. The optical medium as recited in claim 1, wherein the substrate is constructed of fused silica quartz.

16. The optical medium as recited in claim 1, wherein the substrate is constructed of carbonite.

17. The optical medium as recited in claim 1, wherein the substrate is constructed of a graphite composite.

18. The optical medium as recited in claim 1, wherein the data track is formed by stamping.

19. The optical medium as recited in claim 1, wherein the data track is formed by electron exposure.

20. The optical medium as recited in claim 1, wherein the data track is formed by ion exposure.

21. The optical medium as recited in claim 1, wherein the data track is formed by at least one of electrons and ions passing through apertures of a mask.

22. The optical medium as recited in claim 1, wherein the data track includes audio data.

23. The optical medium as recited in claim 1, wherein the data track includes video data.

24. The optical medium as recited in claim 1, wherein the data track includes software.

25. An optical medium, comprising:
a substrate having a data area and a periphery; and
a supplemental layer coupled to the substrate in at least the data area, the supplemental layer having a data track thereon being readable with an optical reader,
wherein the substrate and supplemental layer are constructed of a corrosion-resistant material that does not substantially deteriorate over a period of one hundred years.

26. The optical medium as recited in claim 25, wherein the supplemental layer is recessed from a bottom plane of the medium.

27. The optical medium as recited in claim 26, wherein the data track has a focal depth about the same as a focal depth of a compact disc (CD).

28. The optical medium as recited in claim 27, further comprising a second data area and a second supplemental layer positioned on an opposite side of the substrate.

29. The optical medium as recited in claim 28, wherein the second supplemental layer is recessed from a top plane of the medium.

30. The optical medium as recited in claim 25, further comprising a peripheral flange extending downwardly from the periphery.

31. The optical medium as recited in claim 25, wherein the data track has a generally spiral shape.

32. The optical medium as recited in claim 25, further comprising a protective coating covering the supplemental layer.

33. The optical medium as recited in claim 25, wherein the supplemental layer includes multiple data sublayers.

34. The optical medium as recited in claim 25, wherein the optical medium is readable by a consumer-grade compact disc (CD) player.

35. The optical medium as recited in claim 25, wherein the optical medium is readable by a consumer-grade digital video disc (DVD) player.

36. The optical medium as recited in claim 25, wherein the optical medium is readable by a reader capable of reading surface features finer than a consumer-grade digital video disc (DVD) player.

37. The optical medium as recited in claim 25, wherein the supplemental layer is constructed of gold.

38. The optical medium as recited in claim 25, wherein the supplemental layer is constructed of ceramic.

39. The optical medium as recited in claim 25, wherein the supplemental layer is constructed of stainless steel.

40. The optical medium as recited in claim 25, wherein the supplemental layer is constructed of fused silica quartz.

41. The optical medium as recited in claim 25, wherein the supplemental layer is constructed of carbonite.

42. The optical medium as recited in claim 25, wherein the supplemental layer is constructed of a graphite composite.

43. The optical medium as recited in claim 25, wherein the supplemental layer includes a dye sublayer.

44. The optical medium as recited in claim 25, wherein the data track is formed by stamping.

45. The optical medium as recited in claim 44, wherein the data track is formed by energy exposure.

46. The optical medium as recited in claim 25, wherein the data track is formed by electron exposure.

47. The optical medium as recited in claim 25, wherein the data track is formed by ion exposure.

48. The optical medium as recited in claim 25, wherein the data track is formed by at least one of electrons and ions passing through apertures of a mask.

49. The optical medium as recited in claim 25, wherein the data track includes audio data.

50. The optical medium as recited in claim 25, wherein the data track includes video data.

51. The optical medium as recited in claim 25, wherein the data track includes software.

52. An optical medium, comprising:
a substrate having a central hub, an outer periphery, and a data area extending between the hub and periphery, the data area having a data track thereon being readable with an optical reader,
wherein the substrate is constructed of a corrosion-resistant material that does not substantially deteriorate over a period of one hundred years;
wherein no material covers the data track,
wherein the data area is recessed from a bottom plane of the medium.

53. The optical medium as recited in claim 52, wherein the data track has a focal depth about the same as a focal depth of a compact disc (CD).

54. The optical medium as recited in claim 52, wherein the substrate is constructed of a material selected from a group consisting of gold, ceramic, stainless steel, fused silica quartz, carbonite, a graphite composite, and combinations thereof.

55. The optical medium as recited in claim 52, wherein the data track is formed by stamping.

56. The optical medium as recited in claim 52, wherein the data track is formed by electron exposure.

57. The optical medium as recited in claim 52, wherein the data track is formed by ion exposure.

58. The optical medium as recited in claim 52, wherein the data track is formed by at least one of electrons and ions passing through apertures of a mask.

59. An optical medium, comprising:
a substrate having a central hub, an outer periphery, and a data area extending between the hub and periphery,
a supplemental layer coupled to the data area, the supplemental layer having a data track thereon,
wherein the substrate is constructed of a corrosion-resistant material that does not substantially deteriorate over a period of one hundred years;
wherein the data area is recessed from a bottom plane of the medium.

60. The optical medium as recited in claim 59, wherein the data track has a focal depth about the same as a focal depth of a compact disc (CD).

61. The optical medium as recited in claim 59, wherein the substrate and supplemental layer are constructed of a material selected from a group consisting of gold, ceramic, stainless steel, fused silica quartz, carbonite, a graphite composite, and combinations thereof.

62. The optical medium as recited in claim 59, wherein the data track is formed by stamping.

63. The optical medium as recited in claim 59, wherein the data track is formed by electron exposure.

64. The optical medium as recited in claim 59, wherein the data track is formed by ion exposure.

65. The optical medium as recited in claim 59, wherein the data track is formed by at least one of electrons and ions passing through apertures of a mask.
